(19) United States
(12) Patent Application Publication
(10) Pub. No.: US 2018/0106230 A1
(43) Pub. Date: Apr. 19, 2018

(54) System and Method for Starting a Multi-Engine Power System

(71) Applicant: Caterpillar Inc., Peoria, IL (US)

(72) Inventors: Josenia Y. Gerdes, Dunlap, IL (US); Perry D. Converse, Lafayette, IN (US); Ed Schroeder, Germantown Hills, IL (US); Robert Murray, Peoria, IL (US); Vijay Janardhan, Dunlap, IL (US)

(73) Assignee: Caterpillar Inc., Peoria, IL (US)

(21) Appl. No.: 15/296,750

(22) Filed: Oct. 18, 2016

(51) Int. Cl. F02N 9/04; F02B 63/04; F02D 25/00; H02P 9/04; H02K 7/18

(52) U.S. Cl. CPC F02N 9/04; F02B 63/04; F02N 2300/2011; H02P 9/04; H02K 7/1815; F02D 25/00

(57) ABSTRACT

A power system is provided that includes a plurality of engines and a compressed air source in communication with the plurality of engines and configured to assist in starting the engines. A plurality of engine controllers are provided each associated with a respective one of the plurality of engines. The engine controllers are communicatively linked with each other and upon receipt of a signal to start the plurality of engines are configured to stagger the starts of the plurality of engines according to a predetermined order and to apply an air start system charge delay timer before starting an individual engine when the compressed air source is in a first state in which the compressed air source is unable to assist starting at least one of the plurality of engines.

### TECHNICAL FIELD

This disclosure relates generally to a plurality of engines arranged together to generate power, more particularly, to a system and method for starting a plurality of engines in a power system.

### BACKGROUND

A generator set (generator set) includes a combination of a generator and a prime mover, for example, a combustion engine. As a mixture of fuel and air is burned within the engine, a mechanical rotation is created that drives the generator to produce electrical power. In some applications, the electrical power demanded of the generator set is greater than can be supplied by a single generator set and, thus, multiple generator sets are connected in parallel to meet the demands in these situations.

The engines in a multiple generator set power system may be started by various starting systems, including an air start system and an electric start system. An electric start system may draw electric power from an electric source, such as a battery bank or from other engines already running, for example. However, an electric start system may increase wear of the associated electric power source and with an associated starter motor.

An air start system can avoid these issues. An air start system may draw compressed air from a compressed air source, such as a compressed air tank, for example. The compressed air source is used to provide compressed air for starting rotation of the crankshaft of the engine. An air start system, however, may be ineffective for starting an engine of the power system if the amount of compressed air provided by the compressed air source is less than what is required to start the engine.

U.S. Pat. No. 6,653,821 (“the '821 patent”) discloses a system controller and method for monitoring and controlling a plurality of generator sets. A user interface allows a user to select a generator set and set values for various predetermined operating parameters of the selected generator set. This can include a priority of operation of the generator sets and parameters for starting and stopping the generator sets. The controller and method disclosed in the '821 patent, however, does not address any of the issues associated with starting a plurality of generator set engines using a common compressed air source.

### SUMMARY

In one aspect, the disclosure describes a power system. The power system includes a plurality of engines and a compressed air source in communication with the plurality of engines and configured to assist in starting the engines. A plurality of engine controllers are provided each associated with a respective one of the plurality of engines. The engine controllers are communicatively linked with each other and upon receipt of a signal to start the plurality of engines are configured to stagger the starts of the plurality of engines according to a predetermined order and to apply an air start system charge delay timer before starting an individual engine when the compressed air source is in a first state in which the compressed air source is unable to assist starting at least one of the plurality of engines.

In another aspect, the disclosure describes a method for sequentially starting a plurality of engines in a power system using a compressed air source. The power system includes a plurality of engine controllers each associated with a respective one of the plurality of engines. The method includes the steps of:
(a) determining the un-started engine with a highest start priority based on communication between the plurality of engine controllers;
(b) waiting to start the un-started engines other than the engine with the highest start priority;
(c) determining if the compressed air source is in a first state in which the compressed air source is unable to assist starting at least one of the plurality of engines;
(d) delaying start of the engine with the highest start priority according to an air start system charge delay timer if the compressed air source is in the first state;
(e) starting the engine with the highest start priority after expiration of the air start system charge delay timer; and
(f) repeating steps (a) through (e) until all engines are started.

In yet another aspect, the disclosure describes a control system for starting a plurality of engines of a power system. The control system includes a compressed air source in communication with plurality of engines and configured to assist in starting the engines. The system includes a plurality of engine controllers each associated with a respective one of the plurality of engines, the engine controllers being communicatively linked with each other and configured to:
(a) determining the un-started engine with a highest start priority based on communication between the plurality of engine controllers;
(b) wait to start the un-started engines other than the engine with the highest start priority;
(c) determine if the compressed air source is in a first state in which the compressed air source is unable to assist starting at least one of the plurality of engines;
(d) delay start of the engine with the highest start priority according to an air start system charge delay timer if the compressed air source is in the first state;
(e) start the engine with the highest start priority after expiration of the air start system charge delay timer;
(f) repeat steps (a) through (e) until all engines are started.

### BRIEF DESCRIPTION OF THE DRAWINGS

FIG. 1 is a schematic illustration of an illustrative multi-engine power system according to the present disclosure.

FIG. 2 is a flowchart embodying an exemplary control system and method for starting the multi-engine power system of FIG. 1.

### DETAILED DESCRIPTION

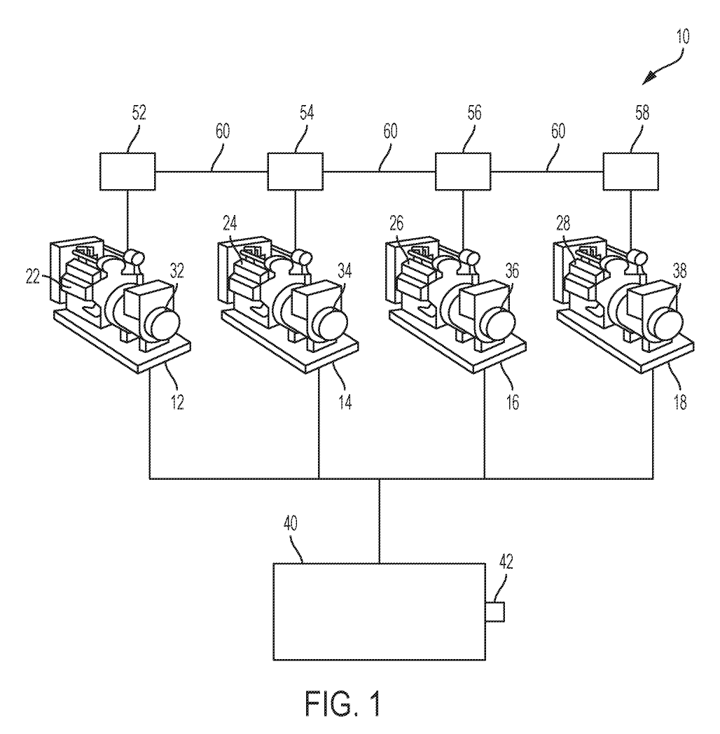

This disclosure relates to a power system including a plurality of internal combustion engines and the control strategies and electronic or digital controllers for directing start-up of the plurality of engines. Now referring to the drawings, wherein like reference numbers refer to like elements, there is illustrated in FIG. 1 a power system 10 having a plurality of generator sets that may be configured to provide primary and/or backup power to an external load. As shown in FIG. 1, each generator set 12, 14, 16, and 18 includes an internal combustion engine 22, 24, 26, and 28, and a generator 32, 34, 36, and 38, respectively. Internal combustion engines 22, 24, 26, and 28 are drivingly connected to respective generators 32, 34, 36, and 38, for example by flexible couplings. To provide fuel for the engines to combust, the power system 10 may be operably associated with one or more fuel tanks or reservoirs.

It is contemplated that the power system 10 may include any number of a plurality of generator sets, for example, two, three or four generator sets (as shown in the exemplary embodiment of FIG. 1). In other embodiments, any suitable number of generator sets may be provided. It is contemplated that a power system 10 could include identical generator sets, all different generator sets, or any other configuration of generator sets, as desired. Similarly, the engines 22, 24, 26 and 28 associated with each of the generator sets 12, 14, 16 and 18 may be identical, all different or any other configuration of engines as desired. For example, the power system 10 may include two larger medium-speed generator sets and two smaller high-speed generator sets. The larger medium-speed generator sets may be capable of greater power output at higher fuel efficiency (i.e., lower fuel consumption) and/or lower emissions. The smaller high-speed generator sets, however, may be capable of faster transient response and high-efficiency low-load operation. By including a mix of different types and/or sizes of generator sets, benefits associated with the different sets may be realized.

Generator sets 12, 14, 16, and 18 may include features not shown, such as engine fuel systems, engine air systems, cooling systems, peripheries, drivetrain components, etc. Furthermore, generator sets 12, 14, 16, and 18 may be of any size, and in any configuration. For example, internal combustion engines 22, 24, 26, and 28 may include any number of cylinders, in any configuration (“V,” in-line, radial, etc.), and may be powered with any type of fuel including, but not limited to, diesel, gasoline, and/or gaseous fuel. Still further, generator sets 12, 14, 16, and 18 may be used in mobile or stationary power plants, or to power any machine or other device including, but not limited to, locomotive applications, on-highway trucks or vehicles, off-highway trucks or machines, earth moving equipment, oil and gas applications, marine applications, pumps, stationary equipment, or other generator set powered applications. While the electrical capacity of the generator sets 12, 14, 16, and 18 described herein may be rated at any suitable quantity, an exemplary generator set may produce several kilowatts and the combination of the generator sets may together produce several hundred kilowatts.

In some embodiments, the mechanical outputs of some or all of the engines 22, 24, 26, and 28 may be routed directly to loads (e.g., mechanically routed to the loads). Accordingly, the present disclosure is not limited to power systems 10 in which each or any of the engines 22, 24, 26, and 28 are associated with an electrical generator. Rather, the present disclosure is applicable to any power system 10 that includes a plurality of engines.

To assist in starting the engines 22, 24, 26, and 28, the power system 10 may include a compressed air source, such as for example a compressed air tank 40. As shown schematically in FIG. 1, the compressed air tank 40 may be in communication with each of the plurality of engines 22, 24, 26, and 28. Each engine 22, 24, 26, and 28 may be configured to use an air start system in which the respective engine draws compressed air from the compressed air tank 40 that is then used by the engine 22, 24, 26, and 28 to start rotation of the crankshaft of the engine. For example, the engines 22, 24, 26, and 28 equipped with the air start system may use compressed air to turn an air-powered starter motor that is configured to crank the respective engine. The compressed air tank 40 may have an associated pump or air compressor that may be used to replenish the supply of compressed air. As discussed further below, the compressed air tank 40 may also have an associated air pressure sensor 42 that may be configured to provide signals indicative of the pressure of the air in the compressed air tank 40.

Each engine 22, 24, 26, and 28 or generator set 12, 14, 16, and 18 may have an associated engine controller 52, 54, 56, and 58 for operating the respective engine 22, 24, 26, and 28. For example, the engine controllers 52, 54, 56, and 58 may adapt a load, speed, air intake amount, air intake pressure, fueling amount, ignition timing etc. of the respective engine 22, 24, 26, and 28. The engine controllers 52, 54, 56, and 58 may include, among other things, a single or multiple microprocessors, digital signal processors (DSPs), etc. that include means for controlling, among others, an operation of various components of the respective engine 22, 24, 26, and 28. Further, the engine controllers 52, 54, 56, and 58 may be general engine control unit (ECU) capable of controlling numerous functions associated with the respective engine 22, 24, 26, and 28 and/or its associated components. Still further, the engine controllers 52, 54, 56, and 58 may include a processor, an application specific integrated circuit (ASIC), or other appropriate circuitry for performing logic and digital functions or any other means known in the art for controlling the respective engine 22, 24, 26, and 28 and its components, and may have associated memory or similar data storage capabilities. Still further, the engine controllers 52, 54, 56, and 58 may analyze and compare received and stored data and, based on instructions and data stored in memory or input by a user, determine whether action is required.

The individual engine controllers 52, 54, 56, and 58 may be linked together via a communication system 60, e.g. a network, (shown schematically in FIG. 1) that provides signal and/or data connectivity between the engine controllers 52, 54, 56, and 58. This communication system may be configured to allow the individual engine controllers 52, 54, 56, and 58 to operate and communicate with each other using digital signals, analog signals, or through any other suitable means. For example, the individual engine controllers 52, 54, 56, and 58 may communicate with each other via datalinks or other methods. The communication system 60 may be, but not limited to, a wide area network (WAN), a local area network (LAN), an Ethernet, an Internet, an Intranet, a cellular network, a satellite network, or any other suitable network for transmitting data between the engine controllers 52, 54, 56, and 58. In various embodiments, the communication system 60 may include a combination of two or more of the aforementioned networks and/or other types of networks known in the art. The communication system 60 may be implemented as a wired network, a wireless network or a combination thereof.

To facilitate a start up of the group of engines 22, 24, 26, and 28 associated with the power system 10, the individual engine controllers 52, 54, 56, and 58 may be configured to communicate and arbitrate among themselves to determine which engine 22, 24, 26, and 28 will crank first and the order in each engine 22, 24, 26, and 28 will begin its start sequence. This crank arbitrate feature implemented by the engine controllers 52, 54, 56, and 58 can stagger the engine starts in a group of engines 22, 24, 26, and 28 that share a common compressed air tank 40 for use during start up. Generally, the compressed air tank 40 will not have sufficient capacity to be capable of starting all of the engines 22, 24, 26, and 28 at once thus the starts may need to be staggered. To this end, the engine controllers 52, 54, 56, and 58 may be configured such that each engine 22, 24, 26, and 28 in the power system 10 will start up sequentially according to a predetermined order as long as there is sufficient air pressure (e.g., as indicated by the air pressure sensor) present in the compressed air tank 40. The engine controllers 52, 54, 56, and 58 may be further configured such that when insufficient pressurized air is present, each engine 22, 24, 26, and 28 that is starting will delay its start based on a predetermined and programmable air start system charge timer to help ensure that there is sufficient air for the engine 22, 24, 26, and 28 to complete its start sequence. The air start system charge timer may correspond to the amount of time required for a pump or compressor to recharge the compressed air tank 40. Information regarding the status of the crank arbitrate feature may be communicated to an operator of the power system 10 through an appropriate operator interface such as, for example, a display screen.

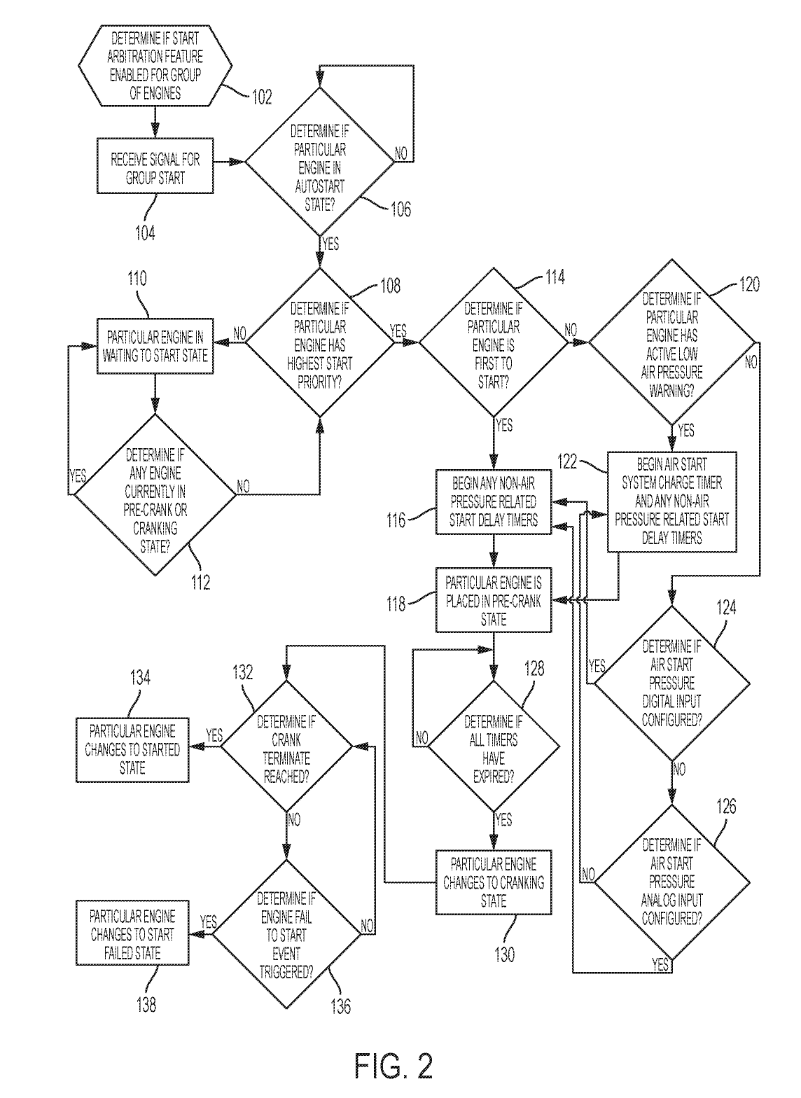

Referring to FIG. 2, there is a provided a flow chart of an exemplary multi-engine start up control system and method or process that may be implemented by the individual engine controllers 52, 54, 56, and 58 in order to provide a staggered start for the engines 22, 24, 26, and 28 associated with the generator sets 12, 14, 16, and 18. The steps of the system and process described herein may be embodied as machine readable and executable software instructions, software code, or executable computer programs. The software instructions may be further embodied in one or more routines, subroutines, or modules and may utilize various auxiliary libraries and input/output functions to communicate with other equipment. An operator of the power system may interact with the system and process through the operator interface.

In step 102, it is determined whether the start arbitration system and process is enabled for the group of engines 22, 24, 26, and 28 associated with the generator sets 12, 14, 16, and 18. The enablement of the start arbitration feature may be a system wide set point among the engine controllers 52, 54, 56, and 58 associated with the group of engines 22, 24, 26, and 28. If the start arbitration system and process is disabled, the group of engines 22, 24, 26, and 28 may start according to a predetermined start strategy, which may involve the group of engines starting together. In step 104, the engine controllers 52, 54, 56, and 58 receive a signal for a group start of the engines 22, 24, 26, and 28.

A determination whether each particular engine 22, 24, 26, and 28 is in an autostart state is made in step 106. The autostart state indicates that the particular engine 22, 24, 26, and 28 is in a state or configuration in which it may be started automatically. If a particular engine 22, 24, 26, and 28 is not in an autostart state, the engine will not begin the start sequence; rather the system will continue to check whether that particular engine 22, 24, 26, and 28 has been placed in an autostart state. If the particular engine 22, 24, 26, and 28 is in the autostart state, the process moves to step 108 where it is determined if a particular engine 22, 24, 26, and 28 has the highest start priority among the group of engines. This decision may rely upon communication between the engine controllers 52, 54, 56, and 58 associated with the engines 22, 24, 26, and 28. The priority of the individual engines 22, 24, 26, and 28 can be based on any desired consideration such as, for example, the engine with the lowest operating hours or be determined randomly.

If the particular engine 22, 24, 26, and 28 does not have the highest priority to start, the engine controller 52, 54, 56, and 58 associated with that engine may place the engine into a waiting to start state as reflected by step 110. Next, the associated engine controller 52, 54, 56, and 58 determines if any engine is currently in a pre-crank state or a cranking state in step 112. Again, this determination may be based on communication between the individual engine controllers 52, 54, 56, and 58. If one of the group of engines 22, 24, 26, and 28 is in either the pre-crank or cranking state, the system and process may cycle back to step 110 and the particular engine remains in the pre-cranking state. If none of the group of engines 22, 24, 26, and 28 is in the pre-crank or cranking state then the system and process may again consider whether a particular engine 22, 24, 26, and 28 has the highest start priority (step 108).

If the associated engine controller 52, 54, 56, and 58 determines that it is its engine's 22, 24, 26, and 28 turn to start (i.e., it becomes the engine with the highest start priority) the system and process proceeds to step 114 where it is determined whether that particular engine 22, 24, 26, and 28 is the first to start. Again, this step 114 may rely upon communication between the engine controllers 52, 54, 56, and 58 for the group of engines 22, 24, 26, and 28. If the particular engine 22, 24, 26, and 28 is the first to start, the system and process may move to step 116 wherein any non-air pressure related start delay timers are begun. These timers may include, for example, a crank alert timer and/or a start aid timer. The crank alert timer may provide time for an audible and/or visual alert to be sounded in the vicinity of the engine 22, 24, 26, and 28 prior to beginning the start sequence. The start aid timer may provide time for a start aid, such as for example ether, to be applied to the engine 22, 24, 26, and 28 prior to the beginning of the engine start sequence. In association with the beginning of the non-air pressure related start delay timers, the particular engine 22, 24, 26, and 28 may be placed in a pre-crank state in step 118.

Returning to step 114, if it is determined that the particular engine is not the first to start, the system and process may proceed to step 120 wherein based on communication between the engine controllers 52, 54, 56, and 58 it is determined if any of the engines 22, 24, 26, and 28 has an active low air pressure warning. This warning may be based on information or signals provided by the pressure sensor 42 or on information input by a user of the power system 10. If no low air pressure warning is found among the group of engines 22, 24, 26, and 28, the system and process may proceed to step 124 where it may be determined whether an air pressure digital input is configured either to a single engine controller 52, 54, 56, and 58 or to multiple engine controllers within the power system 10. The air pressure digital input may provide information to so-configured engine controller whether sufficient air pressure is present or is not present in the compressed air tank 40 to start the particular engine 22, 24, 26, and 28. If the air start pressure digital input is not configured, the system and process may determine in step 126 whether an air pressure analog input is configured to either a single or multiple engine controllers 52, 54, 56, and 58. The air pressure analog input may provide information to the so-configured controller 52, 54, 56, and 58 regarding the specific air pressure in the compressed air tank 40. With this information, the particular engine controller 52, 54, 56, and 58 may determine whether sufficient pressurized air is present in the compressed air tank 40 to start the particular engine 22, 24, 26, and 28.

In sum, the low air pressure warning may be triggered due to a digital or analog input configured for air pressure on the particular engine controller 52, 54, 56, and 58 or if the low air pressure event is communicated to the particular engine controller 52, 54, 56, and 58 from one of the other engine controllers over the communication system 60. Likewise, if the low pressure event is no longer active, the particular engine controller 52, 54, 56, and 58 may communicate that inactive status to the other engine controllers in the power system 10. If one engine controller 52, 54, 56, and 58 detects a low air pressure warning but another engine controller does not detect the low pressure warning, the system and process may be configured to operate conservatively and assume the presence of a low air pressure warning.

As shown in FIG. 2, if either one of the air pressure analog and digital inputs are configured (steps 124 an 126) and no low air pressure warning is active, an air start system delay may be deemed unnecessary and the process may proceed to step 116 wherein the non-air pressure start delay timers are begun and to step 118 where the particular engine 22, 24, 26, and 28 is placed in the pre-crank state. If neither the air pressure analog nor digital input is configured, the system and process may operate conservatively and proceed to step 122 where the air start system charge timer is applied.

Returning to step 120, if an active low air pressure warning is present, the system and process may proceed to step 122 where the air start system charge timer is applied. In particular, in step 122, the air start system charge timer is begun concurrently along with any non-air pressure related start delay timers. As discussed in connection with step 116, these non-air pressure related start delay timers might include, for example, a start alert timer and/or a start aid timer. As noted above, the air start system charge timer, may be set to a value corresponding to at least a sufficient time for the compressed air tank 40 to be brought back to a predetermined air pressure adequate to start the particular engine 22, 24, 26, and 28. In association with the beginning of the air start system charge timer, the system and process may place the particular engine 22, 24, 26, and 28 in the pre-crank state.

In step 118, whether all of the applicable timers have expired is determined. In this regard, the system and process may be configured such that the particular engine 22, 24, 26, and 28 does not proceed to the next step until the longest of the applicable timers has expired. Once the applicable timers have expired, the particular engine 22, 24, 26, and 28 may be placed in a cranking state by the associated engine controller 52, 54, 56, and 58. The system and process then determines if crank terminate has been reached in step 132 and if crank terminate has been reached the particular engine 22, 24, 26, and 28 is changed to a started state in step 134. If crank terminate has not been reached, the system and process may determine in step 136 whether an engine failed to start event has been triggered. If such an event has been triggered, the particular engine 22, 24, 26, and 28 may have its state changed to failed to start in step 138.

### INDUSTRIAL APPLICABILITY

The disclosed power system 10 and process for controlling the power system 10 may be applicable to any application that may require power provided by multiple engines and with which a common pressurized air source is used to assist starting of the engines. For example, the disclosed power system 10 and control method may be applicable to oil and gas applications, temporary and fixed power generation applications, and marine and/or petroleum drilling vessel applications, where the power sources cooperate to propel the vessel and to power auxiliary loads under varying conditions. The disclosed power system and process may allow for an optimized start up of the multiple engines that can avoid issues resulting from an engine attempting to start up when the compressed air source has insufficient pressurized air to start the engine.

Because the system and method of the present disclosure may be implemented with the individual engine controllers, it can eliminate the need a more expensive separate controller that controls the group engine start-ups. Likewise, because the system and process of the present disclosure may arbitrate among the engines and determine which engine will start first and the order in which each engine will begin the start sequence and then apply a time delay when insufficient pressurized air is present, the system and process can eliminate the need for a larger, more expensive compressed air source.

This disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A power system comprising:
a plurality of engines;
a compressed air source in communication with the plurality of engines and configured to assist in starting the engines;
a plurality of engine controllers each associated with a respective one of the plurality of engines, the engine controllers being communicatively linked with each other and upon receipt of a signal to start the plurality of engines configured to stagger the starts of the plurality of engines according to a predetermined order and to apply an air start system charge delay timer before starting an individual engine when the compressed air source is in a first state in which the compressed air source is unable to assist starting at least one of the plurality of engines.

2. The power system of claim 1 wherein each engine has an associated generator driven by the respective engine.

3. The power system of claim 2 further including a pressure sensor configured to provide signals indicative of a pressure associated with the compressed air source.

4. The power system of claim 1 wherein at least one of the engine controllers is in communication with the pressure sensor and wherein the plurality of engine controllers are configured to communicate with each other regarding the first state of the compressed air source.

5. The power system of claim 1 wherein the plurality of engine controllers are configured to apply at least one non-air pressure related start delay timer before starting an individual engine and to concurrently begin the non-air pressure related start delay timer and the air start system charge delay timer and to start the individual engine upon expiration of the longest of the air start system charge delay timer and the non-air pressure related start delay timer.

6. The power system of claim 1 wherein the first state is an active low air pressure warning.

7. The power system of claim 1 wherein the plurality of engine controllers are configured such that the air start system charge delay timer is not applied to a first of the plurality of engines to start.

8. A method for sequentially starting a plurality of engines in a power system using a compressed air source, the power system including a plurality of engine controllers each associated with a respective one of the plurality of engines, the method comprising the steps of:
(a) determining the un-started engine with a highest start priority based on communication between the plurality of engine controllers;
(b) waiting to start the un-started engines other than the engine with the highest start priority;
(c) determining if the compressed air source is in a first state in which the compressed air source is unable to assist starting at least one of the plurality of engines;
(d) delaying start of the engine with the highest start priority according to an air start system charge delay timer if the compressed air source is in the first state;
(e) starting the engine with the highest start priority after expiration of the air start system charge delay timer; and
(f) repeating steps (a) through (e) until all engines are started.

9. The method of claim 8 further including the step of sensing a pressure associated with the compressed air source using a pressure sensor.

10. The method of claim 9 wherein at least one of the engine controllers is in communication with the pressure sensor and wherein the plurality of engine controllers are configured to communicate with each other regarding the first state of the compressed air source.

11. The method of claim 8 further including the step of applying at least one non-air pressure related start delay timer before starting an individual engine wherein the non-air pressure related start delay timer and the air start system charge delay timer are begun concurrently and the engine with the highest start priority is started upon expiration of the longest of the air start system charge delay timer and the non-air pressure related start delay timer.

12. The method of claim 8 wherein the first state is an active low air pressure warning.

13. The method of claim 8 wherein steps (c) through (e) are not performed in relation to a first of the plurality of engines to start.

14. A control system for starting a plurality of engines of a power system, the control system comprising:
a compressed air source in communication with plurality of engines and configured to assist in starting the engines; and
a plurality of engine controllers each associated with a respective one of the plurality of engines, the engine controllers being communicatively linked with each other and configured to:
(a) determining the un-started engine with a highest start priority based on communication between the plurality of engine controllers;
(b) wait to start the un-started engines other than the engine with the highest start priority;
(c) determine if the compressed air source is in a first state in which the compressed air source is unable to assist starting at least one of the plurality of engines;
(d) delay start of the engine with the highest start priority according to an air start system charge delay timer if the compressed air source is in the first state;
(e) start the engine with the highest start priority after expiration of the air start system charge delay timer; and
(f) repeat steps (a) through (e) until all engines are started.

15. The control system of claim 14 wherein each engine has an associated generator driven by the respective engine.

16. The control system of claim 14 further including a pressure sensor configured to provide signals indicative of a pressure associated with the compressed air source.

17. The control system of claim 16 wherein at least one of the engine controllers is in communication with the pressure sensor and wherein the plurality of engine controllers are configured to communicate with each other regarding the first state of the compressed air source.

18. The control system of claim 14 wherein the plurality of engine controllers are configured to apply at least one non-air pressure related start delay timer before starting an individual engine and to concurrently begin the non-air pressure related start delay timer and the air start system charge delay timer and to start the individual engine upon expiration of the longest of the air start system charge delay timer and the non-air pressure related start delay timer.

19. The control system of claim 14 wherein the first state is an active low air pressure warning.

20. The control system of claim 14 wherein the plurality of engine controllers are configured such that the air start system charge delay timer is not applied to a first of the plurality of engines to start.
